(19) United States
(12) Patent Application Publication
(10) Pub. No.: US 2009/0015543 A1
(43) Pub. Date: Jan. 15, 2009

(54) Frame-shifted backlight-scaled display system and frame-shifted backlight scaling method

(76) Inventors: Wei-Hsin Wei, Jhubei City (TW); Jing-Meng Liu, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,720

(22) Filed: Jul. 10, 2008

(30) Foreign Application Priority Data
Jul. 13, 2007 (TW) 096125674

(51) Int. Cl. G09G 3/36

(52) U.S. Cl. 345/102

(57) ABSTRACT

In a backlight scaling method and system, the pixel values of a first frame are counted to obtain a first histogram of this frame simultaneously when the first frame is inputted to the data driver ICs, and a first backlight luminance generated according to the first histogram is applied to the backlight driver for the backlight scaling for a second frame when the derived second frame is inputted to the data driver after the pixel values of the second frame is recalculated by the first backlight luminance. In the same way, when the derived second frame is inputted to the data driver, the original pixel values of the second frame are counted to obtain a second histogram of this frame and to generate a second backlight luminance for the third frame, and so on. Because the backlight luminance for each frame is generated according to the histogram of the previous frame, only small amount of pixel buffers for the processing is required.

### FIELD OF THE INVENTION

The present invention is related generally to a display system and, more particularly, to the backlight scaling of a display system.

### BACKGROUND OF THE INVENTION

For portable electronic devices using battery as the power source, such as cell phone, personal digital assistant (PDA), digital camera and digital video recorder, the power consumption mainly comes from the display system thereof, and the backlight unit in the display system consumes most of the power. In a transmissive display, a concept of backlight scaling has been proposed to reduce the power consumption of the backlight unit. The backlight scaling technique dynamically dims the backlight to conserve its power consumption as increasing the panel transmittance to maintain the same luminance. The observed luminance L of a transmissive object is the product of the luminance b of the light source and the transmittance t of the object. For a pixel on a transmissive thin film transistor liquid crystal display (TFT-LCD), its transmittance is a function of its pixel value x. Thus its observed luminance

L=t(x)·b [Eq-1]

The power consumption of the backlight is a strong function of its output luminance. On the contrary, the power consumption of the LCD panel is almost constant so that it is independent of the panel transmittance. Therefore, it may decrease the backlight luminance b to save the power consumption and increase the panel transmittance t accordingly such that the luminance L remains the same. If the backlight-scaled image is identical to the original image in terms of the brightness of each pixel, then there is no fidelity loss after backlight scaling. In addition, higher transmittance can reduce the light leakage phenomenon of liquid crystals and increase the image quality.

In a backlight-scaled TFT-LCD display, the optimized backlight luminance b for each frame can be extracted by counting all the pixel values x of the current frame to figure out the probability distribution of the gray levels in this frame as a current histogram. Then, the new pixel value x′ of this frame and the corresponding display transmittance t(x′) for each pixel can be derived by the current histogram and the optimized backlight luminance b. For more detailed illustration, FIG. 1 shows a conventional backlight scaled display system 100, in which the pixel values x(n) of a frame n from a pixel serial interface are inputted to a timing controller 130 through an input connector 110 and stored in a frame buffer 120, low voltage power inputs VCC and GND are connected to a DC/DC converter and gamma voltage generator 140 through the input connector 110 to provide an appropriate power for the timing controller 130, scan driver integrated circuits (ICs) 152 and data driver ICs 154, and high voltage inputs HV_VDD and HV_GND are connected to a backlight driver 150 through another connector 112. The timing controller 130 reads out all the pixel values x(n) of the frame n from the frame buffer 120 to generate a histogram by counting the pixel values x(n) to figure out the gray level probability distribution in the frame n, determines an optimum backlight luminance b(n) for the frame n according to the histogram thereafter, and recalculates with all the pixels x(n) of the frame n according to the optimum backlight luminance b(n) to produce new pixel values x′(n). To display the image in the frame n, the timing controller 130 provides the new pixel values x′(n) to the data driver ICs 154 and the scan driver ICs 152 to drive the display panel 160 to have corresponding transmittance t(x′), and provides the optimum backlight luminance b(n) to the backlight driver 150 to drive the backlight device 170 to provide backlight 172 for the display panel 160. Although this scheme realizes a real-time backlight-scaling, as shown in FIG. 1, a frame buffer 120 composed by huge memory is required to store the pixel values x before the histogram is extracted. The cost of the frame buffer 120 is not low.

Therefore, it is desired a low-cost frame-shifted method for backlight scaling that does not require frame buffer and the system cost can be reduced.

### SUMMARY OF THE INVENTION

One object of the present invention is to provide a backlight scaling method and system in a frame-shifted manner.

Another object of the present invention is to provide a backlight scaling method and system without requiring much more frame buffer.

According to the present invention, a frame-shifted backlight scaled display system has a timing controller to determine a backlight luminance according to the pixel values of a current frame and to recalculate the pixel values of a next frame according to the backlight luminance, a backlight device to provide backlight according to the backlight luminance, and a display panel to have a corresponding transmittance according to the recalculated pixel values when displaying the image in the next frame.

By using the pixel values of the current frame to determine the backlight luminance and thereby the transmittance of the display panel for the next frame, the huge frame buffer to store the frame data is eliminated, and this method can be applied not only to CCFL and WLED backlight displays but also to RGB backlight ones.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a schematic view showing a conventional backlight-scaled display system; and

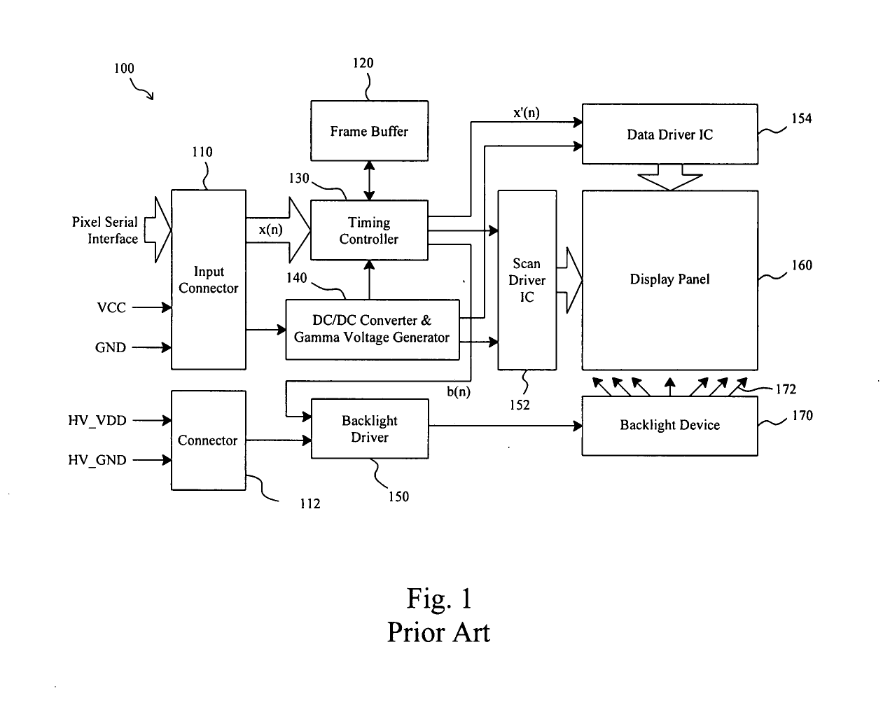

FIG. 2 is a schematic view showing a frame-shifted backlight-scaled display system according to the present invention.

### DETAILED DESCRIPTION OF THE INVENTION

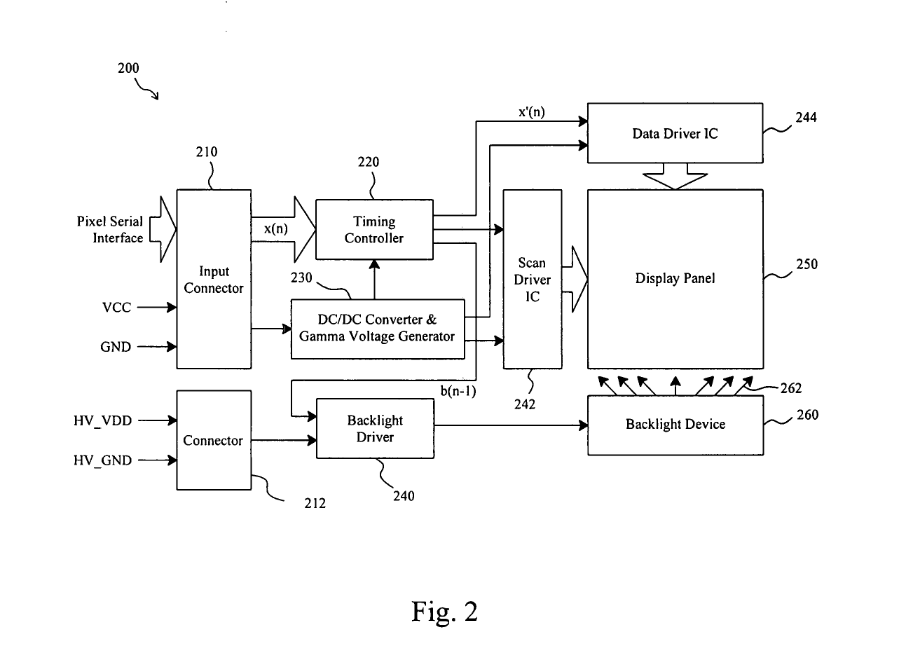

FIG. 2 shows a preferred embodiment of the present invention. A frame-shifted backlight-scaled display system 200 has a DC/DC converter and gamma voltage generator 230 connected with low voltage inputs VCC and GND through the input connector 210, to provide power for a timing controller 220, scan driver ICs 242 and data driver ICs 244, and a backlight driver 240 is connected with high voltage inputs HV_VDD and HV_GND through a connector 212. The data driver ICs 244 and the scan driver ICs 242 constitute a driving apparatus to drive a display panel 250 according to the pixel values provided by the timing controller 220. The backlight driver 240 drives a backlight device 260 according to the backlight luminance determined by the timing controller 220, to provide backlight 262 for the display panel 250. When the pixel values x(1) of a first frame inputted from a pixel serial interface to the data driver ICs 244 through the input connector 210 and the timing controller 220, the timing controller 220 will statistically count the pixel values x(1) to obtain a histogram h1 corresponding to the first frame, and determine a corresponding backlight luminance b(1) according to the histogram h1 of the probability distribution of the gray levels in the first frame. When the pixel values x(2) of a second frame is inputted to the timing controller 220 from the pixel serial interface through the input connector 210, the timing controller 220 will recalculate the pixel values x(2) of the second frame according to backlight luminance b(1) produced from the first frame to generate new pixel values x′(2) for the data driver ICs 244 to drive the display panel 250 to have a corresponding transmittance t(x′,2). The backlight driver 240 drives the backlight device 260 according to the backlight luminance b(1) provided by the timing controller 220 to provide backlight 262 for the display panel 250 when displaying the image in the second frame. Meanwhile, the timing controller 220 statistically counts the original pixel values x(2) of the second frame to obtain a histogram h2 of the probability distribution of the gray levels in the second frame, and scales the backlight 262 for a third frame according to the backlight luminance b(2) corresponding to the histogram h2. In other words, the equation Eq-1 is modified to be

L(n)=t(x′,n)·b(n−1) [Eq-2]

where L(n) is the observed luminance of the n-th frame on the display panel 250, and x′ are recalculated from the original pixel values x of the frame n with based on the previous backlight luminance b(n−1). The adjacent frames typically have very similar histograms, and the human eyes are not sensitive to the minor difference between two sequential frames, and therefore it will not influence the image quality when using the histogram of the previous frame to get the backlight luminance and corresponding new pixel values for the current frame. Furthermore, the backlight scaling of the current frame is performed by referring the histogram and the corresponding backlight luminance of the previous frame, resulting in backlight power reduction. Since using the current frame for the backlight scaling of the next frame, only a small amount of pixel buffer is needed instead of a huge frame buffer.

Moreover, the pixel values that can be displayed by a display system are within a range. If the pixel values generated after the backlight scaling does not fall within the proper range, the image displayed by the display system 200 will distort. Therefore, the optimum backlight luminance is the minimum value to make the pixel values be out of the proper range. For example, for a display system 200 that can display with the pixel values within the range of 0-255, in the situation of without backlight scaling, i.e., the backlight luminance b=1, if the histogram of the pixel values of the current frame ranges at 10-100, then the minimum value bₘᵢₙ of the backlight luminance generated according to the current frame is

$$\frac{100}{255} .$$

Since the backlight luminance for the backlight scaling of the next frame is generated from the current frame, and the pixel values of the next frame is not exactly the same with that of the current frame, it may therefore select

$$b = \frac{1}{2}$$

to prevent the pixel values of the next frame after the backlight scaling from being out of the range of 0-255 and resulting in image distortion. In this case, the backlight luminance is reduced from 1 to ½, and thus the power consumption is reduced to half of the original level.

In another embodiment, each pixel of the frame is composed of red, green and blue sub-pixels, the display panel 250 includes a TFT-LCD panel, and the backlight device 260 includes a white backlight device composed of a white light source and a color filter. The white light source may include a cold cathode fluorescent lamp (CCFL), a white LED, a white OLED or the white light generated by mixing red, green and blue light sources. The pixel values x of the frame includes gray level values, and the timing controller 220 statistically counts the pixel gray level values of the frame to generate the histogram of the pixel gray level values, and determines a white backlight luminance b_{w} according to the histogram. The sub-pixel luminance is determined by the product of the white backlight luminance b_{w} and the transmittance of each color

$$[ \begin{matrix}{L}_{R} \\ {L}_{G} \\ {L}_{B}\end{matrix} ] = {b}_{W} \cdot [ \begin{matrix}{t}_{R} \\ {t}_{G} \\ {t}_{B}\end{matrix} ] \qquad [ Eq \text{-} 3 ]$$

where L_{R}, L_{G} and L_{B} are the luminance of the red, green and blue sub-pixels respectively, and t_{R}, t_{G} and t_{B} are the transmittance of the display panel 250 corresponding to the red, green and blue sub-pixels respectively. Different colors are displayed on the display panel 250 by scaling t_{R}, t_{G} and t_{B}. For example, when the luminance ratio L_{R}:L_{G}:L_{B} of red, green and blue colors is 3:6:1, the color displayed on the display panel 250 is white.

In still another embodiment, the backlight device 260 includes a color backlight device composed of color light sources such as red, green and blue light sources, the pixel values x of the frame includes color values such as color values of red, green and blue, and the timing controller 220 statistically counts the pixel color values of the frame to generate the histogram of the pixel color values, and generates corresponding color backlight luminance b_{R}, b_{G} and b_{B} according to the histogram. The sub-pixel luminance is determined by the product of the color backlight luminance b_{R}, b_{G}, b_{B} and the transmittance of each color. Therefore, the equation Eq-3 is modified to be

$$[ \begin{matrix}{L}_{R} \\ {L}_{G} \\ {L}_{B}\end{matrix} ] = [ \begin{matrix}{b}_{R} & 0 & 0 \\ 0 & {b}_{G} & 0 \\ 0 & 0 & {b}_{B}\end{matrix} ] \cdot [ \begin{matrix}{t}_{R} \\ {t}_{G} \\ {t}_{B}\end{matrix} ] \qquad [ Eq \text{-} 4 ]$$

where b_{R}, b_{G} and b_{B} are red, green and blue backlight luminance respectively. The equation Eq-4 can be applied in spatial and temporal color mixing methods. For example, by disposing a color filter on a conventional TFT-LCD display panel, a spatial color mixing method is implemented. Otherwise, by continuously generating red, green and blue colors in a very short time period such that human eyes cannot observe the difference in time, a temporal color mixing method is implemented. This temporal color mixing method is called color sequential display. Because the spatial color mixing method displays the red, green and blue components of a pixel by red, green and blue sub-pixels respectively, while the temporal color mixing method uses the same pixel structure for the red, green and blue components, the temporal color mixing method may increase the pixel density and thereby increase the resolution of the display panel or reduce the size of the display panel.

In still another embodiment, the color backlight device includes a color light source and a color transform unit. The color light source includes a blue light source, for example blue LED or blue OLED, and the pixel values x of the frame includes blue color values. The timing controller 220 statistically counts the blue color values of the pixels of the frame to generate a histogram of the blue color values, and determines a blue backlight luminance b_{B} according to the histogram for backlight scaling of the blue luminance L_{B}. Corresponding red luminance L_{R} and green luminance L_{G} are generated by the color transform unit according to the blue luminance L_{B}.

As illustrated by the above embodiments, the present invention provides a backlight scaling method and system in a frame-shifted manner, which does not require much more frame buffer and results in a low cost solution.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A frame-shifted backlight-scaled display system, comprising:
a timing controller determining a backlight luminance according to pixel values of a first frame and recalculating pixel values of a second frame according to the backlight luminance;
a display panel having a corresponding transmittance according to the recalculated pixel values of the second frame; and
a backlight device providing backlight according to the backlight luminance for the display panel when displaying an image in the second frame.

2. The display system of claim 1, wherein the second frame is the one next to the first frame.

3. The display system of claim 1, further comprising a driving apparatus driving the display panel according to the recalculated pixel values of the second frame when displaying the image in the second frame.

4. The display system of claim 3, wherein the driving apparatus comprises data driver integrated circuits and scan driver integrated circuits both connected to the display panel.

5. The display system of claim 1, further comprising a backlight driver driving the backlight device according to the backlight luminance.

6. The display system of claim 1, wherein the pixel values of the first frame comprises gray level values.

7. The display system of claim 1, wherein the pixel values of the first frame comprises color values.

8. The display system of claim 1, wherein the backlight luminance comprises a white backlight luminance.

9. The display system of claim 1, wherein the backlight luminance comprises a color backlight luminance.

10. The display system of claim 1, wherein the display panel comprises a TFT-LCD display panel.

11. The display system of claim 1, wherein the backlight device comprises a color backlight device or a white backlight device.

12. The display system of claim 11, wherein the color backlight device comprises red, green and blue light sources.

13. The display system of claim 11, wherein the color backlight device comprises:
a color light source; and
a color transform unit.

14. The display system of claim 13, wherein the color light source comprises a blue light source.

15. The display system of claim 14, wherein the blue light source comprises a blue LED or a blue OLED.

16. The display system of claim 11, wherein the white backlight device comprises:
a white light source; and
a color filter.

17. The display system of claim 16, wherein the white light source comprises one of CCFL, white LED, white OLED and white light mixed from red, green and blue light sources.

18. A frame-shifted backlight scaling method, comprising the steps of:
determining a backlight luminance according to pixel values of a current frame;
recalculating pixel values of a next frame according to the backlight luminance; and
displaying an image in the next frame according to the recalculated pixel values and the backlight luminance.

19. The method of claim 18, wherein the step of determining a backlight luminance according to pixel values of a current frame comprises the steps of:
statistically counting pixel gray level values of the current frame to generate a histogram of the gray level values; and
determining a white backlight luminance according to the histogram.

20. The method of claim 18, wherein the step of determining the backlight luminance according to pixel values of a current frame comprises the steps of:
statistically counting pixel color values of the current frame to generate a histogram of the color values; and
determining a color backlight luminance according to the histogram.
